(19) United States
(12) Patent Application Publication
(10) Pub. No.: US 2009/0126364 A1
(43) Pub. Date: May 21, 2009

(54) CONVECTIVE/RADIATIVE COOLING OF CONDENSER COOLANT

(75) Inventors: David R. Mills, Palo Alto, CA (US); Robert C. Mierisch, Palo Alto, CA (US); Robert D. Sumpf, JR., Menlo Park, CA (US); Laura L. Chao, Stanford, CA (US)

Correspondence Address: MORRISON & FOERSTER LLP, 755 PAGE MILL RD, PALO ALTO, CA, 94304-1018, US

(73) Assignee: Ausra, Inc., Palo Alto, CA (US)

(21) Appl. No.: 12/135,039

(22) Filed: Jun. 6, 2008

Related U.S. Application Data
(60) Provisional application No. 60/933,574, filed on Jun. 6, 2007.

(51) Int. Cl. B60K 16/00; F24J 2/30; F24J 2/10

(52) U.S. Cl. 60/641.8; 126/645; 126/696

(57) ABSTRACT

A system for effecting cooling of a coolant fluid is provided, the system comprising: a solar energy collector system; and fluid channels for the coolant fluid that are at least partially above ground level and are at least partially shaded by the solar energy collector system. The system may comprise a system for cooling a condenser coolant fluid in a thermal power plant incorporating a solar energy collector system, the system comprising: one or more solar energy reflectors; and fluid channels for the coolant fluid that are at least partially above ground level and are at least partially shaded by one or more of the solar energy reflectors. Solar energy reflector carrier arrangements for use in said system, and methods and thermal power plants utilizing said system are further provided.

### CROSS-REFERENCE TO RELATED APPLICATION

This application claims the benefit under 35 U.S.C. § 119(e) of U.S. Provisional Application Ser. No. 60/933,574, filed Jun. 6, 2007, the contents of which is incorporated herein by reference in its entirety.

### FIELD OF THE INVENTION

This invention relates to a method of and an arrangement and system for effecting cooling of a coolant fluid, including effecting cooling of condenser coolant in a thermal power plant that employs solar energy reflectors.

### BACKGROUND OF THE INVENTION

A thermal power plant typically comprises a steam producing plant, a steam turbine to which the steam is fed, a condensing plant located downstream from the turbine and a cooling system associated with the condensing plant. Also included in the power plant are such ancillary components and systems as provide for fluid reticulation, fluid storage, water/steam separation and heat recuperation, and the turbine is employed to drive an associated electrical generator. The working fluid (in its liquid phase) may comprise water alone or a water-mixture containing an additive such as ammonia.

The various types of known steam producing plants include fossil fuel fired steam generators, nuclear reactor powered steam generating plants, and solar energy collector system plants. The types of condensing plants that variously are employed in power plants are determined in part by output power requirements and the availability (or otherwise) of a local natural heat sink such as a lake or river system. However, they typically comprise shell-and-tube condensers or direct contact condensers and they employ coolant water to which latent and sensible heat is transferred in the steam condensing process.

In the absence of sufficiently large natural heat sinks, the various known condensers require cooling systems for the coolant water. Thus, heat must be removed from the coolant water before it is cycled back through a condenser, and the most common method of achieving this is by employment of evaporative cooling. However, evaporative (wet) cooling towers lose water to evaporation and require sources of clean top-up water for sustained operation. Also, their open construction permits pollution of the coolant water by contaminants from the atmosphere and, whilst controlled draining and chemical treatments are in practice employed to minimize the concentration of contaminants, evaporative cooling remains unsuitable for use with direct contact condensers.

Dry cooling towers are employed as alternatives to evaporative cooling towers in situations where, for example, the levels of water lost to evaporation cannot reasonably be accommodated. These towers employ forced air cooling of the coolant water, as it is recirculated in a closed circuit, but the dry cooling process is less efficient than evaporative cooling. Thus, dry cooling towers are limited in their cooling capacity by the prevailing temperature of ambient air. Also, higher condensing pressures, resulting from higher coolant temperatures under high ambient temperature conditions, cause a reduction to occur in output performance of turbines from which low pressure steam is exhausted for condensing.

A further, recently developed, cooling system employs subterranean cooling for condenser coolant and in this respect reference is made to International Patent Application PCT/AU2007/000268 dated 2 Mar. 2007.

All patents, patent applications, documents, and articles cited herein are herein incorporated by reference in their entirety.

### SUMMARY OF THE INVENTION

The present invention provides a system, apparatus, and method for cooling a coolant fluid, such as cooling a condenser coolant fluid in a thermal power plant incorporating a solar energy collector system having solar energy reflectors, as well as a thermal power plant incorporating said system and/or apparatus.

In one aspect of the invention is a system for cooling a coolant fluid, the system comprising: a solar energy collector system; and fluid channels for the coolant fluid that are at least partially above ground level and are at least partially shaded by the solar energy collector system. In some embodiments, the solar energy collector system comprises a photovoltaic panel. In some embodiments, the solar energy collector system comprises a solar energy reflector. In some embodiments, the system for cooling a coolant fluid comprises a system for cooling a condenser coolant fluid in a thermal power plant incorporating a solar energy collector system, the system comprising: one or more solar energy reflectors; and fluid channels for the coolant fluid that are at least partially above ground level and are at least partially shaded by one or more of the solar energy reflectors. In some embodiments, the fluid channels are on or above the ground. In some embodiments, the fluid channels are on the ground. In some embodiments, the fluid channels are above the ground. In some embodiments, the fluid channels are partially above ground level. In some embodiments, the fluid channels are carried by at least one of the solar energy reflectors. In some embodiments, the fluid channels are in heat conductive relationship with at least one of the solar energy reflectors. In some embodiments, the fluid channels are not carried by the solar energy reflectors. In some embodiments, the fluid channels comprise conduits. In some embodiments, the fluid channels comprise parallel conduits molded into a sheet. In some embodiments, the fluid channels comprise a polymeric material. In some embodiments, the fluid channels comprise a metal. In some embodiments, the fluid channels have an inside diameter of about 10 to about 30 mm. In some embodiments, the fluid channels are fully shaded by the solar energy reflectors. In some embodiments, the system further comprises one or more additional systems for cooling the condenser coolant fluid. The system of the invention may optionally comprise a carrier arrangement for use in a solar energy reflector system as described herein.

In another aspect of the invention is a carrier arrangement for use in a solar energy reflector system which comprises a carrier structure having: a) a support structure for supporting a reflector element; and d) one or more fluid channels attached to the support structure or the reflector element, wherein the fluid channels are at least partially shaded by the reflector element. In some embodiments, the support structure is a platform. In some embodiments, the platform comprises a panel-like platform which is formed with stiffening elements in the form of corrugations and wherein the reflector element is supported upon the crests of the corrugations. In embodiments in which the solar energy reflectors comprise corrugated platforms, the corrugations may themselves constitute the fluid channels. In embodiments in which the solar energy reflectors comprise corrugated platforms, the fluid channels may comprise conduits, wherein the conduits are positioned within at least some of the corrugations. In some embodiments, the conduits are located at the reflector element-side of the platform. In some embodiments, the conduits are located on the reverse side of the platform. In some embodiments, the apparatus comprises a frame portion that includes hoop-like end members between which the platform extends. In some embodiments, the frame portion comprises a space frame. In some embodiments, each of the hoop-like end members has a channel-section circumferential portion, and wherein the support members comprise spaced-apart supporting rollers which track within the circumferential portion of the associated end member. In some embodiments, the arrangement comprises support members which support the frame portion by way of the end members and which accommodate turning of the carrier structure about an axis of rotation that is substantially coincident with a longitudinal axis of the reflector element when supported by the platform. In some embodiments, the fluid channels are in heat conductive relationship with the platform. In some embodiments, the fluid channels are attached to the platform by frictional engagement. In some embodiments, the fluid channels are attached to the platform by glue. In some embodiments, the fluid channels comprise conduits.

In another aspect of the invention is a method for cooling a coolant fluid, the system comprising: a solar energy collector system; and fluid channels for the coolant fluid that are at least partially above ground level and are at least partially shaded by the solar energy collector system. In some embodiments, the for cooling a coolant fluid comprises a method of cooling a condenser coolant fluid in a thermal power plant incorporating a solar energy collector system, the method comprising directing the coolant fluid through the fluid channels of a system for cooling a condenser fluid as described herein. The system for cooling a condenser fluid may optionally comprise a carrier arrangement for use in a solar energy reflector system as described herein.

In another aspect of the invention is a method of cooling a condenser coolant fluid, the method comprising directing the coolant fluid through the fluid channels of a carrier arrangement for use in a solar energy reflector system as described herein.

In another aspect of the invention is a thermal power plant comprising a heating system that utilizes solar radiation for heating a working fluid, a turbine to which, in operation, the working fluid is delivered, a condenser for condensing vapour exhausted from the turbine, and a cooling system associated with the condenser. The cooling system comprises fluid channels that are at least partially above ground level and are at least partially shaded by one or more solar energy reflectors and are connected in fluid passage communication with the condensing means. In some embodiments, the thermal power plant comprises: (a) a heating system that utilizes one or more solar energy reflectors to collect solar radiation for heating a working fluid; (b) a turbine to which, in operation, the working fluid is delivered; (c) a condenser comprising a coolant fluid for condensing working fluid vapour exhausted from the turbine; and (d) a cooling system associated with the condenser and in fluid passage communication therewith, wherein the cooling system comprises a system for cooling a condenser fluid as described herein. The system for cooling a condenser fluid may optionally comprise a carrier arrangement for use in a solar energy reflector system as described herein. In some embodiments, the heating system comprises a heat exchanger, wherein the one or more solar energy reflectors are utilized to collect solar radiation for heating a heat exchange fluid, wherein the heat exchange fluid heats the working fluid in the heat exchanger. In some embodiments, the heating system comprises at least one field of solar energy reflectors that, during diurnal periods, are arranged to reflect incident solar radiation to at least one receiver for heating the working fluid or, if present, the heat exchange fluid. In some embodiments, the working fluid is water or a hydrocarbon. In some embodiments, the working fluid is water. In some embodiments, the heat exchange fluid is water, silicone oil, or a liquid hydrocarbon. In some embodiments, the heat exchange fluid is water. In some embodiments, the heat exchange fluid is silicone oil. In some embodiments, the heat exchange fluid is a liquid hydrocarbon.

In another aspect of the invention is a thermal power plant comprising means for generating a working fluid, turbine means to which, in operation, the working fluid is directed, means for condensing vapour exhausted from the turbine means and a cooling system associated with the condensing means. The cooling system comprises fluid channels that are at least partially above ground level and are at least partially shaded by at least some of the solar energy reflectors and are connected in fluid passage communication with the condensing means. The means for generating the working fluid may comprise a solar energy collector system having solar energy reflectors. In some embodiments, the thermal power plant comprises: (a) means for generating a heated working fluid, comprising a solar energy collector system having solar energy reflectors; (b) turbine means to which, in operation, the working fluid is directed; (c) means for condensing working fluid vapour exhausted from the turbine means; and (d) a cooling system associated with the condensing means and in fluid passage communication therewith, wherein the cooling system comprises a system for cooling a condenser fluid as described herein. The system for cooling a condenser fluid may optionally comprise a carrier arrangement for use in a solar energy reflector system as described herein.

In operation of the present invention, in one of its various forms, as above defined, sensible and latent heat that is extracted from the working fluid during the condensing process is conveyed by the cooling system (i.e., by the coolant fluid) to fluid channels that are at least partially above ground level and are at least partially shaded by the solar energy reflectors, from which heat is transferred by convection and/or radiation to ambient air, and in some embodiments, additionally by transfer of heat into the solar energy reflectors. In general, to maintain the efficacy of cooling, the fluid channels are situated at least in part to avoid direct solar heating during the daytime hours through being shaded by the solar energy reflectors.

### BRIEF DESCRIPTION OF THE DRAWINGS

FIG. 1 shows a block-diagrammatic representation of elemental components of a thermal power plant.

FIG. 2 shows a more detailed block-diagrammatic representation of a thermal power plant.

FIG. 3 shows a schematic representation of one embodiment of a heating system portion of the thermal power plant, the heating system being in the form of a solar energy collector system and being illustrated in an operating condition.

FIG. 4 shows a perspective view of a portion of one embodiment of the heating system of FIG. 3.

FIG. 5 shows a perspective view of one embodiment of a carrier arrangement of a reflector of the type incorporated in the system as shown in FIG. 4.

FIG. 6 shows a scrap view of a portion of one embodiment of a rotary support arrangement for the reflector of FIG. 5.

FIG. 7 shows a scrap view of a portion of one embodiment of a drive arrangement for the reflector of FIG. 5.

FIG. 8 shows a schematic representation of interconnections made between condenser and cooling system components of a thermal power plant.

FIG. 9 shows a partial end view of one embodiment of a platform for a reflector of the type shown in FIG. 5, with the platform carrying a reflector element and coolant fluid channels in the form of conduits.

FIG. 10 shows a partial end view of a second embodiment of a platform, coolant fluid conduits and a reflector element for a reflector of the type shown in FIG. 5.

FIG. 11 shows an alternative fluting configuration for a platform of the type shown in FIGS. 9 and 10.

FIG. 12 shows a partial end view of one embodiment of a platform for a reflector of the type shown in FIG. 5, with the platform carrying a reflector element and with corrugations of the platform providing integrated coolant fluid channels.

FIG. 13 shows a partial end view of one embodiment of a platform for a reflector of the type shown in FIG. 5, with the platform carrying a reflector element and with integrated coolant fluid channels being formed within corrugations of the platform.

FIG. 14 shows a partial end view of one embodiment of a platform for a reflector of the type shown in FIG. 5, with the platform carrying a reflector element and with integrated coolant fluid channels being formed externally of corrugations of the platform.

FIG. 15A shows a partial view of one embodiment of fluid channels that run perpendicular to a solar energy reflector of the type shown in FIG. 5.

FIG. 15B shows a partial view of one embodiment of fluid channels that run parallel to a solar energy reflector of the type shown in FIG. 5.

FIG. 16 shows a partial end view of one embodiment of fluid channels, with the conduits molded into a sheet.

FIG. 17A shows a partial end view of one embodiment of fluid channels comprising conduits molded into a sheet and at least partially shaded by a solar energy reflector of the type shown in FIG. 5.

FIG. 17B shows a partial end view of one embodiment of fluid channels comprising conduits molded into a sheet and at least partially shaded by a solar energy reflector of the type shown in FIG. 5, wherein the mirror is inverted for washing.

### DETAILED DESCRIPTION OF THE INVENTION

Unless otherwise indicated, all numbers used in the specification and claims are to be understood as being modified in all instances by the term “about.” Accordingly, unless indicated to the contrary, the numerical parameters set forth in the following specification and attached claims are approximations that may vary depending at least upon the specific analytical technique.

The invention will be more fully understood from the following description of various embodiments of a thermal power plant (e.g. a Rankine cycle plant) comprising a system and/or apparatus of the invention and/or their methods of use. However, it is to be understood that the below description is merely for illustration purposes, and that the invention encompasses more generally any system for cooling a coolant fluid, wherein the system comprises a solar energy collector system, and wherein fluid channels for the coolant fluid are at least partially above ground level and are at least partially shaded by the solar energy collector system. The description is provided by way of examples and with reference to the accompanying drawings, which characterizes some preferred embodiments but is by no means limiting.

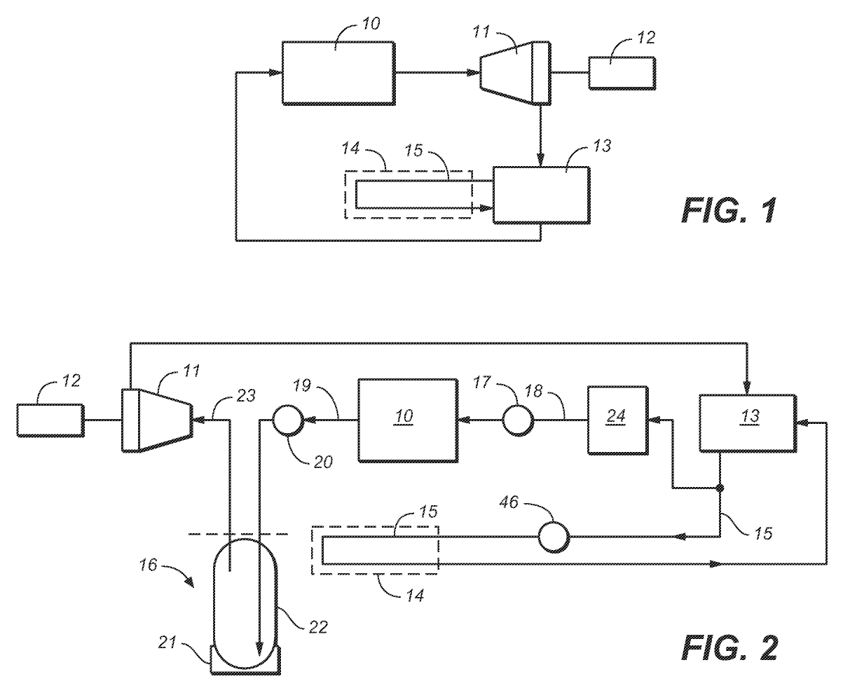

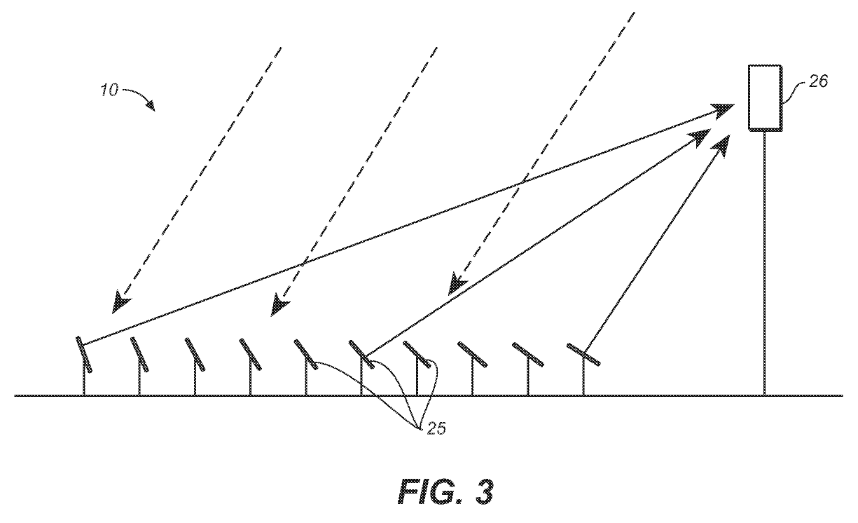

As illustrated in FIG. 1, in one embodiment the thermal power plant comprises a heating system 10 in which thermal energy is transferred to a working fluid. The heating system utilizes solar energy, examples of which are hereinafter described more fully with reference to FIGS. 3 to 8, and the working fluid when heated is delivered to a turbine 11 which is employed to drive an electrical generator 12. Having expanded through the turbine, the working fluid passes to a condenser 13 where residual vapour is condensed to a liquid phase. From the condenser 13 the working fluid is returned to the heating system 10.

The working fluid may comprise water or a hydrocarbon (e.g. pentane) or such other fluid as is suitable for expanding through a turbine. In some embodiments, the working fluid comprises water or, in its vapour/gaseous phase, steam. In some embodiments, the working fluid comprises a water mixture (e.g. water and ammonia). In some embodiments, the working fluid comprises a hydrocarbon.

In some embodiments, the working fluid may be heated by passing it through the (at least one) receiver of the solar energy collector system. In some embodiments, the working fluid may be heated by exchanging heat (e.g. within a heat exchanger system) between an intermediate fluid (“heat exchange fluid”), that is passed through and heated by the receiver, and the working fluid. Suitable fluids for use as a heat exchange fluid include, for example, water, a water mixture (e.g. water and ammonia, a liquid hydrocarbon such as a heat transfer oil, silicone oil, and mineral oil. The working fluid and heat exchange fluid may comprise the same type of fluid or may comprise different fluids, for example, in some embodiments the working fluid may comprise water and the heat exchange fluid may comprise oil. In some embodiments, the solar energy collector system is a linear Fresnel system, and the working fluid is heated by passing it through the (at least one) receiver of the solar energy collector system. In some embodiments, the solar energy collector system is a parabolic trough system, and the working fluid is heated by heat exchange with a heat exchange fluid. In some embodiments, the solar energy collector system is a heliostat system. Additional systems include those described in U.S. patent application titled “Combined Cycle Power Plant,” filed on Jun. 6, 2008; and in U.S. patent application Ser. Nos. 12/012,920; 12/012,829; and 12/012,821; the disclosures of which are herein incorporated by reference in their entirety.

The condenser 13 may comprise one in which the working fluid and a coolant fluid are physically separated and channelled through separate circuits (e.g. a shell and tube condenser or a channelled condenser) in which the working fluid and coolant flow in heat exchange relationship. In some embodiments, the condenser may comprise a direct contact condenser in which the coolant fluid is contacted with the working fluid, as described with reference to FIG. 2.

The condenser coolant fluid may comprise any suitable (liquid or gaseous) fluid. In some embodiments, the coolant fluid comprises water. In some embodiments, the coolant fluid comprises water with an additive. In some embodiments, the coolant fluid comprises a hydrocarbon. The coolant fluid for the condenser may be chosen (as to its composition) by the working fluid that is employed in the system. Generally, the coolant fluid will be the same as the working fluid when the condenser comprises a direct contact condenser.

A cooling system 14 for the condenser coolant includes an arrangement of fluid channels 15 (as herein described) through which the coolant fluid is recirculated when cycling through the condenser 13. As will hereafter be described in greater detail the fluid channels 15 are located at least partially above ground level and are at least partially shaded by one or more solar energy reflectors within the heating system 10. In operation of the thermal power plant, sensible and latent heat that is extracted from the working fluid during the condensing process is conveyed by the cooling system (i.e., by the coolant fluid) to the fluid channels, from which it is transferred by convection and/or radiation to ambient air, and in some embodiments, additionally by transfer to the reflector.

FIG. 2 illustrates one possible implementation of the thermal power plant of FIG. 1 and like reference numerals are used to identify like components of the plant. As illustrated, the thermal power plant incorporates a heating system 10 in the form of a solar energy collector system, a steam turbine 11 coupled to an electrical generator 12, and an optional thermal storage system 16. Ancillary equipment, such as valves and metering devices, as would normally be included in such a plant have been omitted from the drawings as being unnecessary for an understanding of the invention, as have connections and valving arrangements that may be provided for by-passing the thermal storage system 16 and for feeding the steam turbine directly from the solar energy collection system.

As an illustrative example, when water is employed as the working fluid, water at a temperature of about 30° C. to 50° C. may be conveyed to the solar energy collector system 10 by way of a pump 17 and conduit 18 where it is heated to a temperature in the range of, for example, about 200° C. to about 400° C., although higher and lower temperatures are feasible, and is returned via conduit 19 and pump 20 to the lower region of the thermal storage system 16, under a pressure of, for example, about 20 to 150 Bar, for example, about 70 to 100 Bar. In some embodiments, the water is heated to a range of about 270° C. to about 370° C. by the solar energy collector system 10. It is to be understood that the operating temperatures and pressures of the working fluid may vary according to the particular working fluid used, the type of solar energy reflector system, the configuration of the thermal power plant, etc. Additionally, the thermal storage system is an optional component of the thermal power plant, and the heated working fluid may in some embodiments be sent directly to the turbine.

Any suitable thermal storage system may be employed as an optional component of the thermal power plant. The thermal storage system 16 may be located above, below, or partially below ground. As illustrated and as but one non-limiting example, it may comprise a vertically extending cylindrical cavity 21 which is formed within the ground. The cavity 21 may have a diametral dimension that is substantially smaller than the cavity's longitudinal depth, and a cylindrical steel vessel 22 that holds the pressurized water may be positioned within the cavity. The vessel 22 may be formed with a relatively thin wall, having a thickness in the range of, for example, about 6 mm to about 16 mm over a major portion of its extent, and the vessel may be otherwise dimensioned to be a neat fit in the cavity 21, to function as a liner for the cavity. Thus, the cavity itself may effectively form the side and bottom walls of the (pressurized) thermal storage system 16. Examples of other thermal storage systems which may be used include those described in U.S. patent application titled “Granular Thermal Energy Storage Mediums and Devices for Thermal Energy Storage Systems” and filed on Jun. 6, 2008.

When, as described in the above example, the working fluid comprises water, flash steam from the upper region of the thermal storage system 16 may be conveyed to the turbine 11 by a conduit 23. After expanding through the turbine the exiting vapour is directed into the condenser 13 and to a following condensate reservoir 24. The reservoir 24 may accommodate fluctuations in the level of working fluid in the thermal storage system 16 and provide for balancing of transport of the working fluid throughout the plant.

One example of a solar energy collector system 10 is illustrated in a diagrammatic way in FIG. 3. However, it is to be understood that the solar energy collector system 10 described below is merely one possible embodiment, and that various other solar energy collector systems 10 may be utilized in the invention, including but not limited to various linear Fresnel systems, heliostat systems, trough systems (e.g. parabolic trough systems), and dish systems. The solar energy collector system 10 generally comprises a reflector (for reflecting the solar energy to a particular location) and a receiver (for receiving the reflected solar energy and heating the working fluid or heat exchange fluid). The reflector may be remote from and move independently of the receiver, or may be directly connected to and move with the receiver. In some embodiments, the solar energy collector system comprises a linear Fresnel system. In some embodiments, the solar energy collector system comprises a heliostat system. In some embodiments, the solar energy collector system comprises a parabolic trough system. In the case of a thermal power plant having a field of solar energy reflectors, the reflectors are optionally arrayed in parallel rows and each reflector may pivot about one or more axes, such as a horizontal axis. In some embodiments, the reflectors are arrayed in a spiral or concentric circles about a receiver.

Examples of reflectors include, for example, trough-type reflectors, linear Fresnel reflectors, heliostat reflectors, and dish reflectors. Trough-type reflectors comprise a curved reflector, generally rotate along one axis, and focus incident solar radiation to a line (e.g. to a linear receiver). Linear Fresnel reflectors comprise flat or curved reflectors, generally rotate along one axis, and focus incident solar radiation to a line (e.g. to a linear receiver). Heliostat reflectors comprise flat or curved reflectors, generally rotate along one or two axes, and focus incident solar radiation to a point or small area (e.g. to a tower). Dish reflectors comprise a curved dish-shaped reflector, generally rotate along one or two axes, and focus incident solar radiation to a point or small area. The reflector may be carried on a support structure such as a platform. As would be apparent to one of ordinary skill in the art, various carrier arrangements for reflector elements may be used, including those described in more detail below. In general, the reflector element is supported by a support structure, which may comprise a platform or other suitable structure, such as, for example, a framework comprising beams, struts, and/or ribs, pedestal, concrete supports, space frames, metal beam structures, or a self supporting reflector element.

The example of a solar energy collector system 10 illustrated in a diagrammatic way in FIG. 3 comprises a field of arrayed ground-mounted, pivotal reflectors 25 that are driven to track the sun and, in so doing, to reflect incident solar radiation to illuminate an elevated receiver system 26. In the form illustrated, the reflectors 25 pivot about horizontal axes.

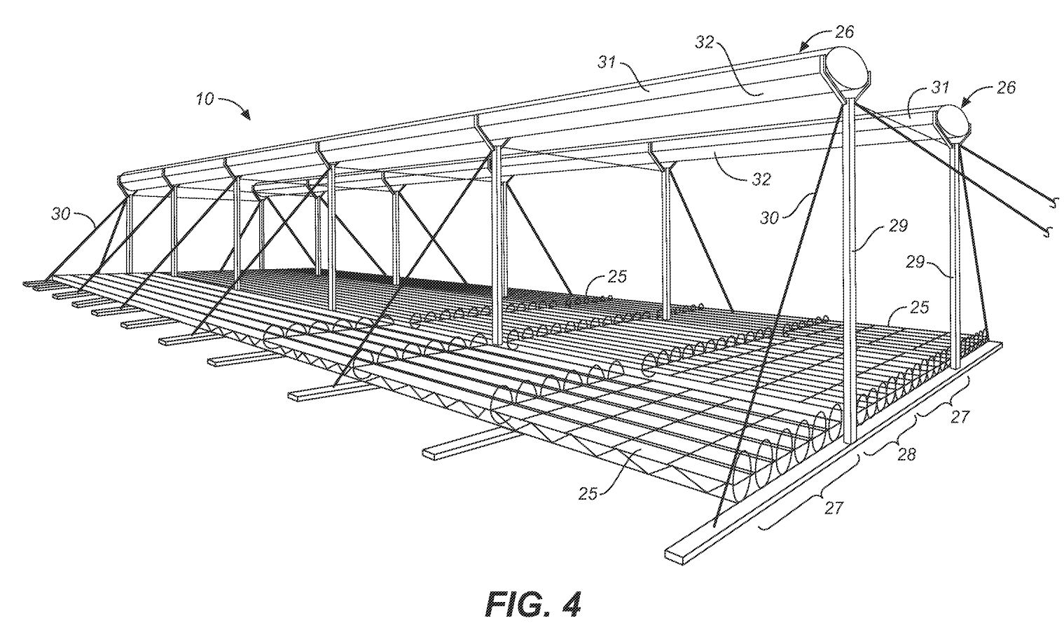

As shown in more detail in the example illustrated in FIG. 4, the solar energy collector system 10 may comprise two notionally separate portions 27 and 28 of ground mounted reflectors 25 that are located in parallel rows that extend generally in the north-south direction, although they may, when appropriately spaced, extend generally in an east-west direction. Also, the solar energy collector system as illustrated in FIG. 4 comprises two parallel receivers 26. The complete solar energy collector system might, for example, occupy a ground area within the range of about 50×10³ m² to about 50×10⁶ m² and the system as shown in FIG. 4 may comprise a representative portion only of the complete solar energy collector system.

In the system as illustrated in FIG. 4, each receiver 26 receives reflected radiation from twelve rows of reflectors 25. Thus, each receiver 26 is illuminated by reflected radiation from six rows of reflectors 25 at one side of the receiver system and from six rows of reflectors 25 at the other side. Each row of the reflectors 25 and, hence, each receiver 26 might typically have an overall length of about 300 to about 600 metres, and the parallel, north-south extending receivers 26 might typically be spaced apart by about 30 to about 35 metres. The receivers 26 are supported at a height of about 10 to about 15 metres by stanchions 29 which are stayed by ground-anchored guy wires 30.

Each of the receivers 26 comprises an inverted trough 31 which is closed at its underside by a longitudinally extending window 32. The window is formed from a sheet of material that is substantially transparent to solar radiation and it functions to define a closed (heat retaining) longitudinally extending cavity within the trough 31. Longitudinally extending metal absorber tubes (not shown) are located in the trough 31 for carrying the working fluid.

Any suitable reflector and receiver structures may be used in the invention. In some embodiments, the reflectors 25 comprise units as disclosed in International Patent Applications PCT/AU2004/000883 and PCT/AU2004/000884, dated 1 Jul. 2004, the disclosures of which are herein incorporated by reference in their entirety. In some embodiments, the receiver systems 26 comprise systems as disclosed in International Application PCT/AU2005/000208, the disclosure of which is herein incorporated by reference in its entirety. Other examples include those described in International Patent Application No. PCT/AU2008/______, entitled “Solar Energy Collector Heliostats” filed Jan. 29, 2008, which claims priority from Australian Provisional Patent Application No. 2007900391, filed Jan. 29, 2007; and in International Patent Application No. PCT/AU2008/000096, entitled “Solar Energy Collector Field Incorporating Collision Avoidance” filed Jan. 29, 2008, which claims priority from Australian Provisional Patent Application No. 2007900390, filed Jan. 29, 2007, the disclosures of which are herein incorporated by reference in their entirety, and which describe various 2-axes heliostat reflector systems.

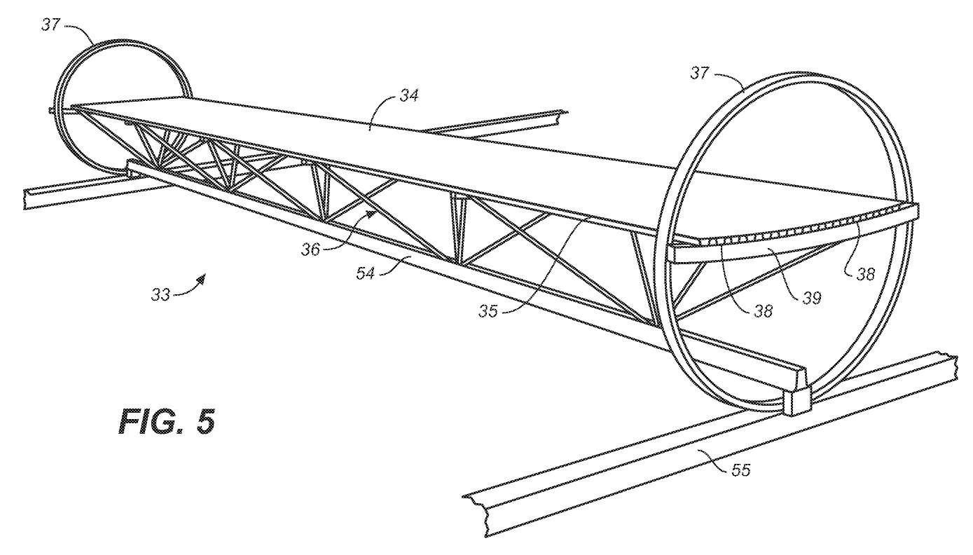

As disclosed in the '883 and '884 references and as illustrated in FIGS. 5 to 7, in one embodiment each solar energy reflector 25 comprises a carrier arrangement 33 to which a reflector element 34 is mounted. The carrier arrangement itself may comprise an elongated panel-like platform 35 which may be supported by a skeletal frame 36 (e.g. a space frame, an example of which is shown in FIG. 5). The frame 36 may include two hoop-like end members 37 and the end members 37 may be centered on and extend about a horizontal axis of rotation that is approximately coincident with a central, longitudinally-extending axis of the reflector element 34. As shown in FIG. 5, the carrier arrangement 33 may comprise a spine member 54 which connects opposite end members 37 and which may be further connected to the space frame 36 as shown. In an alternate embodiment, the carrier arrangement 33 may comprise a skeletal frame 36 (such as a space frame) but not comprise a spine member 54.

The platform 35 may comprise a corrugated metal panel having longitudinally extending corrugations 38 and the reflector element 34 may be supported upon the crests of the corrugations. The platform 35 may be carried by transverse frame members 39 of the skeletal frame 36. End ones of the transverse frame members 39 may effectively comprise diametral members of the hoop-like end members 37.

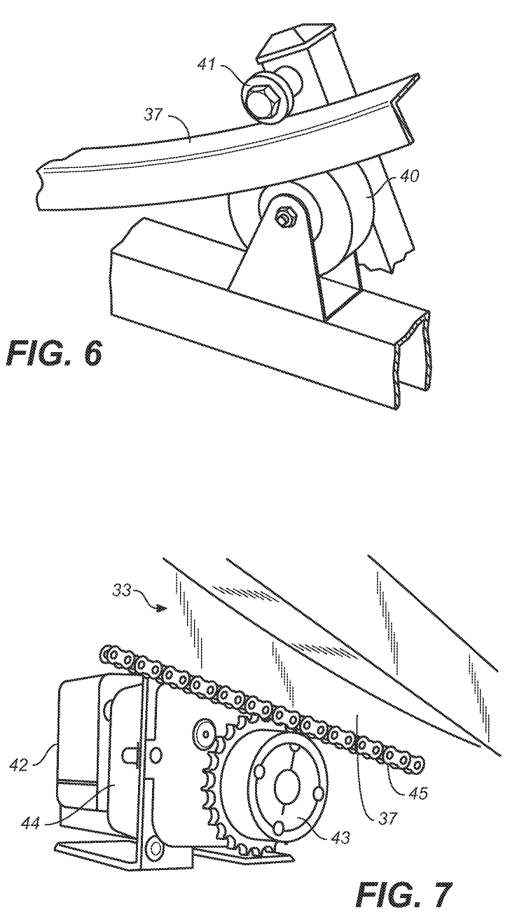

The end members 37 may be formed from channel section steel, such that each end member is provided with a U-shaped circumferential portion and, as shown in FIG. 6, each of the members 37 may be supported for rotation on a mounting arrangement that comprises two spaced-apart rollers 40. The rollers 40 may be positioned to track within the channel section of the respective end members 37, and the rollers 40 provide for rotation of the carrier structure 33. As also shown in FIG. 6, a hold-down roller 41 may be located adjacent the support rollers 40 to prevent lifting of the reflector system under adverse weather conditions.

A drive system as shown in FIG. 7 may be provided for imparting drive (either unidirectional or bidirectional) to the carrier structure 33 and, hence, to the reflector element 34. The drive system may comprise an electric motor 42 having an output shaft coupled to a sprocket 43 by way of reduction gearing 44. The sprocket 43 meshes with a link chain 45 through which drive is imparted to the carrier structure 33. The link chain 45 extends around and is fixed to the periphery of one of the end members 37. In an alternate embodiment, the end members 37 may comprise sprockets within a portion of the U-shaped circumferential portion for engaging a link chain that runs side by side with the rollers 40 within the U-shaped circumferential portion, wherein the link chain is connected to a drive system.

The reflector element 34 may be formed, for example, by appropriately sized glass mirrors or reflective metal sheets. In some embodiments, the reflector element 34 may be formed by butting together a plurality of glass mirrors or reflective metal sheets. In some embodiments, each mirror or sheet may have dimensions of about 1.8 m by about 2.4 m. In some embodiments, each mirror or sheet has a thickness of about 0.003 m. A silicone sealant may be employed to seal gaps around and between the mirrors or sheets, which may be secured to a support structure, such as the crests of the corrugations 30, by a urethane adhesive. In some embodiments, the reflector element comprises one or more glass mirrors.

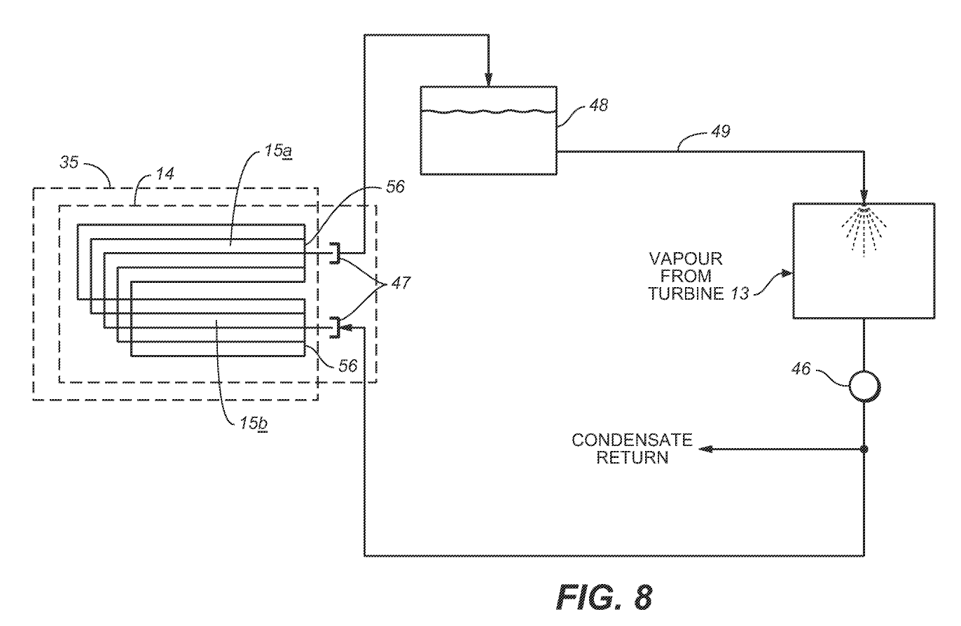

As indicated previously, the condenser 13 may comprise, for example, a direct contact condenser in which the coolant fluid (e.g. water) is contacted with the working fluid for the purpose of extracting sensible and latent heat from the working fluid in the condensing process. Alternatively, the condenser 13 may comprise one in which the working fluid and the coolant fluid are physically separated but in heat exchange relationship. FIG. 8 illustrates an example of the coolant system 14, through which the coolant fluid is passed (by way of a pump 46), comprising a plurality of fluid channels 15 (15a and 15b). A reservoir 48 may optionally be located in circuit between the cooling system 14 and a return line 49 to the condenser, to enable storage of coolant fluid that that is cooled (e.g. during the night time for use during daytime periods of peak insolation).

The fluid channels 15 of the system for cooling a condenser coolant fluid are configured to be at least partially shaded by one or more of the reflectors. In some embodiments, the fluid channels of the cooling system are fully shaded by one or more of the reflectors. The fluid channels of the system are located at least partially above ground level. In some embodiments, the fluid channels are partially above ground level (i.e. partially buried, with a portion of the fluid channels above ground level and a portion below ground level). In some embodiments, the fluid channels are on the ground (i.e. laying on the ground). In some embodiments, the fluid channels are above the ground (i.e. located above the ground and not touching the ground). The fluid channels may also comprise a combination of fluid channels that are partially above ground level, on the ground, and/or above the ground. The fluid channels may also comprise a combination of fluid channels that are on the ground or above the ground.

The fluid channels may comprise any enclosed structure for directing fluid, including any cross-sectional shape, may be rigid or flexible, and furthermore may be made out of any material suitable for transferring heat from the coolant fluid to the ambient air and/or solar energy reflectors. The fluid channels may be comprised of combinations of different types of fluid channels incorporating different materials, flexibilities, and cross-sectional shapes. Suitable materials include, but are not limited to, various metals and polymeric materials, such as steel pipe, and low density polyethylene (LDPE). The fluid channels may be pressurized with air during installation to permit testing for leaks, to exclude ingress of foreign material and to prevent collapsing prior to the admission of the coolant fluid.

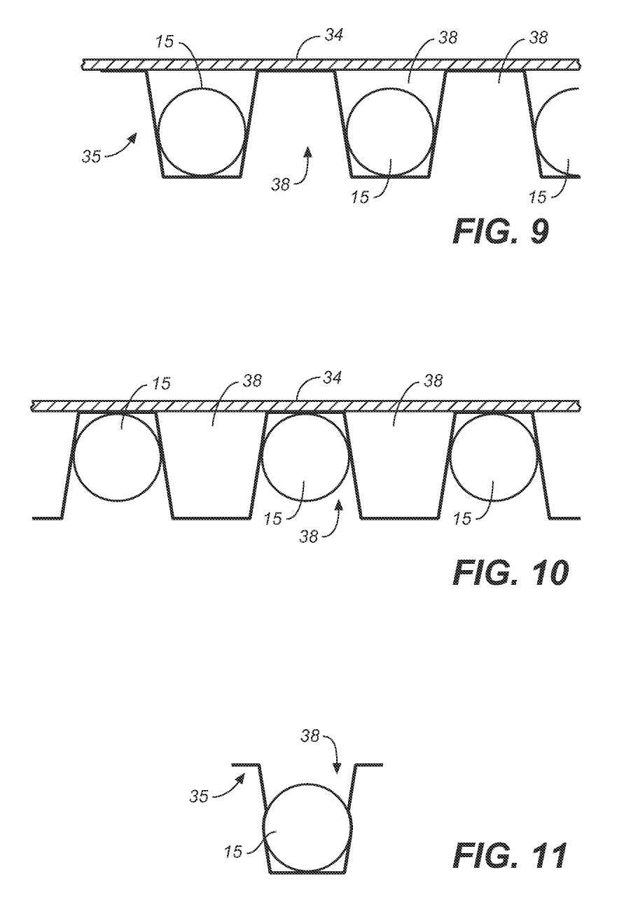

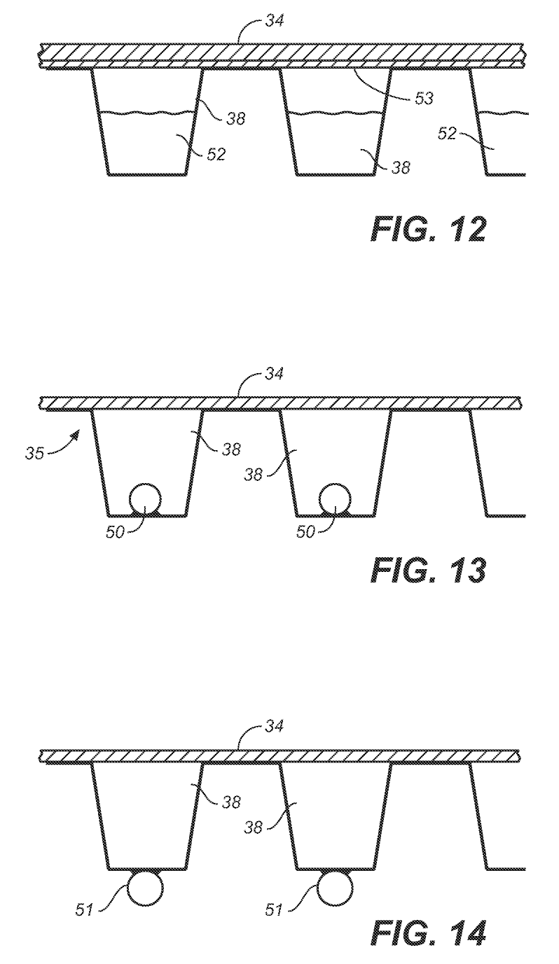

As discussed in more detail below, in some embodiments, the fluid channels are integrated into the structure of the reflector itself, such as shown in FIGS. 12-14. In some embodiments, the fluid channels comprise conduits. Conduits may be comprised out of any material suitable for transferring heat from the coolant fluid to the ambient air and/or solar energy reflectors and may further be rigid or flexible (e.g. flexible hose, tubes, pipes). Non-limiting examples of conduits are shown in FIGS. 9-11, 13-14. In some embodiments, the conduits comprise metal pipe. In some embodiments, the conduits comprise LDPE pipe. In various embodiments, the conduits have an inside diameter in the range of about 5 to about 75 mm, about 10 to about 50 mm, about 20 to about 30 mm, about 10 to about 30 mm. In some embodiments, the conduits have a wall thickness in the range of about 0.5 to about 2.0 mm, for example about 1.0 mm.

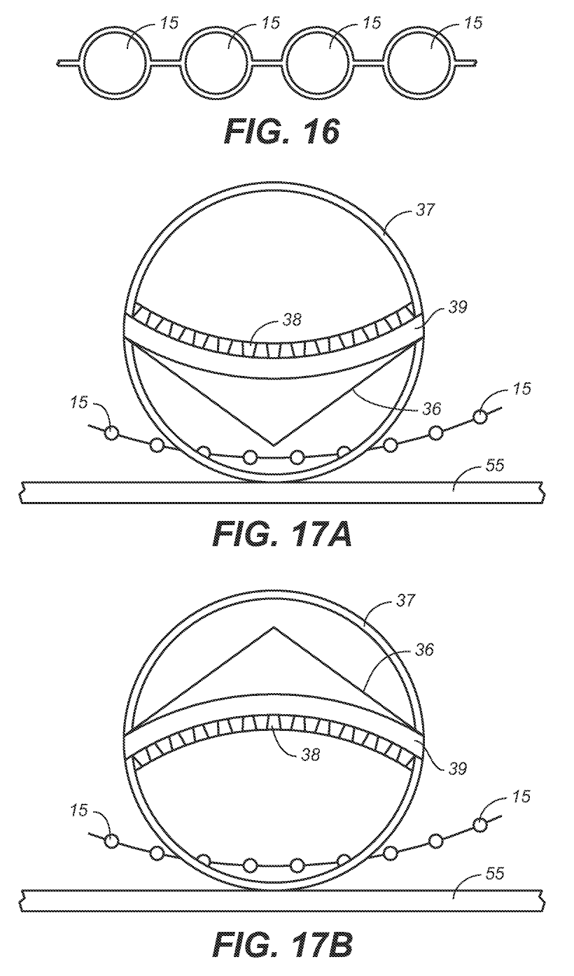

In some embodiments, the fluid channels comprise conduits 15 molded into sheets, as shown in FIG. 16. In some embodiments, the sheets comprise a polymeric material. The conduits 15 in FIG. 16 may, in some embodiments, have an inner diameter of about 1 cm to about 2 cm. As shown in FIG. 17A, the sheet may be arranged under the reflector, in at least partial shade of the reflector. The molded sheets may advantageously be used to collect waste water from washing the reflector elements for reclamation and reuse. As shown in FIG. 17B, the reflector element may be inverted for washing. In this position, water sprayed onto the reflector in order to wash it may drip and be collected by the molded sheet. Additionally, if left in this position overnight, dew collecting on the reflector may be collected by the molded sheet.

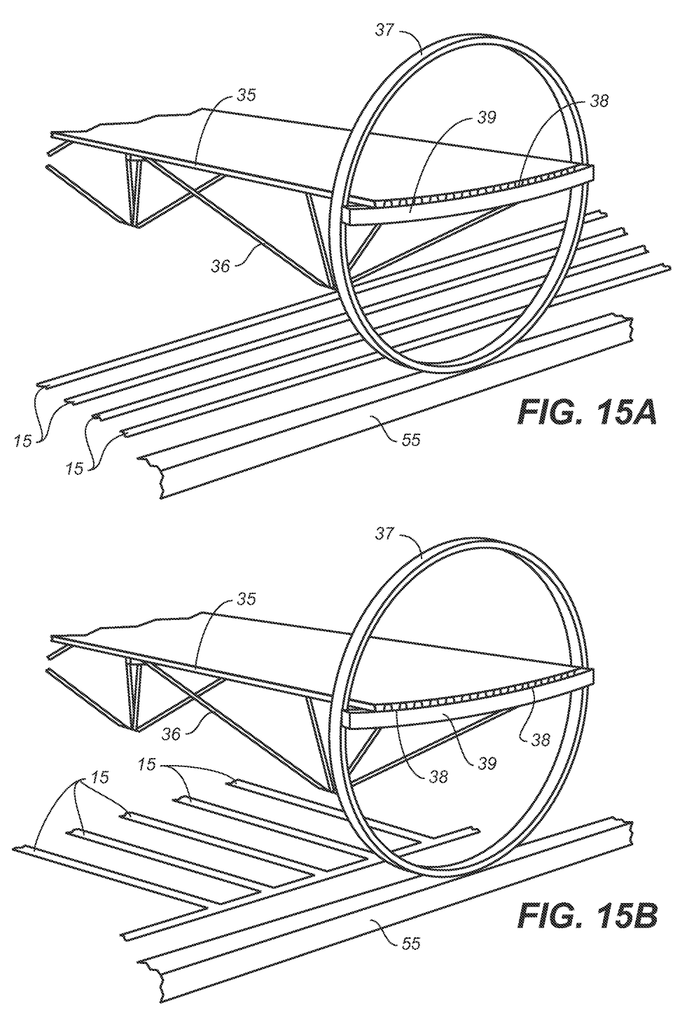

FIG. 15A shows an example of one configuration of the fluid channels 15 of the cooling system, with a solar energy reflector of the type shown in FIG. 5. It is to be understood that this is merely for illustration purposes, and that other types of reflectors may be used in the invention. In FIG. 15A, fluid channels 15 run perpendicular to the horizontal axis of the solar energy reflector. FIG. 15B shows an alternate arrangement, in which the fluid channels 15 run parallel to the horizontal axis of the solar energy reflector. Combinations of parallel and perpendicular arrangements, or other suitable arrangements, may also be used. While only one solar energy reflector is shown in FIGS. 15A and 15B, it is to be understood that multiple solar energy reflectors may be arranged to shade the fluid channels 15. For example, multiple solar energy reflectors may be arrayed in close proximity in parallel rows, such as is shown in FIG. 4, with the fluid channels running under the reflectors. Other suitable reflector configurations will be apparent to one of ordinary skill in the art.

The fluid channels may be separate (i.e. unattached) from the reflectors or may be attached to or integrated with them. For example, the reflector support rail 55 as shown in FIG. 5 may be attached to headers for the fluid channels, or may comprise the fluid channel headers themselves. Additionally, the fluid channels may be attached to the reflector element support structure (e.g. a platform) and/or to other portions of the carrier arrangement and/or to the underside of the reflector element. Fluid channels that are “carried by” a solar energy reflector include fluid channels that are attached to the reflector element support structure and/or to the underside of the reflector element, and are located above ground. Other configurations in which the fluid channels are attached to or integrated with the reflectors (e.g. to the support structure or to the reflector element) are described in more detail below. Other configurations will be apparent to one of ordinary skill in the art.

In some embodiments, the fluid channels may be arranged at an angle in order to allow gravity to direct the flow of coolant fluid through the fluid channels. In some embodiments, the fluid channels may be connected to a pump for directing the flow of coolant fluid. The fluid channels may be configured in various ways, for example, to run in parallel or in series flow. The fluid channels may be configured, for example, to run coolant fluid unidirectionally or in a serpentine manner. Other configurations will be apparent to one of ordinary skill in the art.

As illustrated in FIGS. 9 to 14, the fluid channels 15 may also be positioned in heat conductive relationship with the solar energy reflectors 25, for example by contact with portions of the solar energy reflector that are heat conductive, permitting faster transfer of heat out of the coolant fluid. For example, the fluid channels 15 may comprise conduits that are in contact with the support structure, such as at least some of the platform corrugations 38, as shown in FIGS. 9-11. If the surface area required for absorption and subsequent dissipation of heat from the coolant fluid is sufficiently high, all of the platform corrugations 38 in all of the reflectors 25 may be occupied by the conduits 15.

The conduits 15 may be positioned within the platform corrugations 38 that are located immediately below the reflector element 34, as shown in FIG. 9, or within the corrugations 38 on the reverse side of the platform 35 as shown in FIG. 10. The conduits may be held captive and in heat conductive relationship with the platform 35 by frictional engagement with the side walls of the corrugations 38 or by gluing them in position with a conductive glue. Alternatively, the corrugations 38 may be configured, for example as shown in FIG. 11, to hold the conduits captive following elastic deformation of the conduits during their insertion into the corrugations.

Whereas FIGS. 9 to 11 illustrate arrangements in which the fluid channels for the coolant fluid are constituted by the conduits 15, FIGS. 12 to 14 illustrate arrangements in which the coolant fluid channels are constituted by the corrugations 38 themselves or by pipe-like conduits 50 and 51 that are formed integrally with the corrugations. In the case of the FIG. 12 arrangement, the reflector element 34 cooperates with the corrugations 38 to define each of the fluid channels and, in order to protect the reflective coating on the undersurface of the reflector element from possible deleterious particles in the coolant fluid 52, a plastic sheet material 53 is layered between the reflector element and the crests of the corrugations on which the reflector element sits.

In the case of the arrangements shown in FIGS. 13 and 14, the conduits 50 and 51 may be welded or otherwise attached to the corrugated platform 35 or they may be roll-formed with the corrugations during manufacture of the platform.

FIG. 8 shows diagrammatically a group of fluid channels 15 (15a and 15b) within a single reflector platform 35 but this arrangement may be repeated as many times as there are reflectors 25 in the solar energy collector system 10. The conduits within each reflector 25 may be connected in various ways, including in series-parallel arrangements, but, in the embodiment illustrated in FIG. 8, the conduits in each reflector 25 are connected as two parallel (inflowing and outflowing) groups 15a and 15b, each of which has its own manifold 56. Connection may be made to the manifolds 56 by way of a coaxial swivel coupling 47 or, more simply, by way of flexible hose connections.

As an example of the operation of the above described embodiment of the cooling system as illustrated in FIG. 8, the coolant water at a temperature of about 42° C. is delivered to the conduits 14 under pressure of about 250 kPa and is returned to the condenser 13 at a temperature of about 39° C. under pressure of about 60 kPa. The coolant is, in the described embodiment, delivered to the condenser 13 at a rate of about 320 kg sec⁻¹ to condense steam from the turbine 11 at a temperature of about 44° C. As will be apparent to one of skill in the art, the temperature and pressures of the coolant fluid may vary depending on the type of coolant fluid used, the particular type and arrangement of the thermal power plant and cooling system, etc.

In operation of a thermal power plant as above defined, the cooling system of the invention may comprise one or more of the embodiments described herein (e.g. conduits lying on the ground as well as conduits attached to the platforms). Additionally, the cooling system of the present invention may be employed as the sole cooling system for the coolant fluid, or it may be employed in conjunction with another type of cooling system such as a wet cooling system, a dry cooling system or a subterranean cooling system as disclosed in the above referenced International Patent Application No. PCT/AU2007/000268, which is herein incorporated by reference in its entirety.

The invention may more generally be used in any system for cooling a coolant fluid, wherein the system comprises a solar energy collector system, and wherein fluid channels for the coolant fluid are at least partially above ground level and are at least partially shaded by the solar energy collector system. The solar energy collector system may comprise, for example, a solar energy reflector coupled with a solar energy receiver (such as described above), a photovoltaic panel, or a solar energy reflector coupled with (e.g. pointing at) a photovoltaic panel. For example, the system may be used in conjunction with an air conditioning system, wherein, for example, the coolant fluid (e.g. the refrigerant) of the air conditioning system may be cooled by directing fluid channels for the coolant fluid underneath e.g. roof-mounted photovoltaic panels. This may be useful, for example, in conjunction with a solar energy driven server farm, which has large air conditioning requirements.

Variations and modifications may be made in respect of the cooling systems, methods, apparatus, and thermal power plants as above described without departing from the scope of the invention as described and as defined in the following claims.

1: A system for cooling a coolant fluid, the system comprising:
a solar energy collector system; and
fluid channels for the coolant fluid that are at least partially above ground level and are at least partially shaded by the solar energy collector system.

2: The system of claim 1, wherein the solar energy collector system comprises a photovoltaic panel.

3: The system of claim 1, wherein the solar energy collector system comprises a solar energy reflector.

4: The system of claim 1, wherein the coolant fluid is a condenser coolant fluid in a thermal power plant incorporating the solar energy collector system;
wherein solar energy collector system comprises one or more solar energy reflectors; and
wherein the fluid channels for the condenser coolant fluid are at least partially above ground level and are at least partially shaded by one or more of the solar energy reflectors.

5: The system of claim 1, wherein the fluid channels are on or above the ground.

6: The system of claim 4, wherein the fluid channels are carried by at least one of the solar energy reflectors.

7: The system of claim 6, wherein the fluid channels are in heat conductive relationship with at least one of the solar energy reflectors.

8: The system of claim 4, wherein the fluid channels are not carried by the solar energy reflectors.

9: The system of claim 1, wherein the fluid channels comprise conduits.

10: The system of claim 1, wherein the fluid channels comprise parallel conduits molded into a sheet.

11: The system of claim 11, wherein the fluid channels comprise a polymeric material.

12: The system of claim 1, wherein the fluid channels comprise a metal.

13: The system of claim 1, wherein the fluid channels have an inside diameter of about 10 to about 30 mm.

14: The system of claim 1, wherein the fluid channels are fully shaded.

15: The system of claim 1, further comprising one or more additional systems for cooling the coolant fluid.

16: A method of cooling a coolant fluid, the method comprising directing the coolant fluid through the fluid channels of a system of claim 1.

17: A thermal power plant comprising:
(a) a heating system that utilizes one or more solar energy reflectors to collect solar radiation for heating a working fluid;
(b) a turbine to which, in operation, the working fluid is delivered;
(c) a condenser comprising a coolant fluid for condensing working fluid vapour exhausted from the turbine; and
(d) a cooling system associated with the condenser and in fluid passage communication therewith, wherein the cooling system comprises a system of claim 4.

18: The thermal power plant of claim 17, wherein the heating system comprises a heat exchanger, wherein the one or more solar energy reflectors are utilized to collect solar radiation for heating a heat exchange fluid, wherein the heat exchange fluid heats the working fluid in the heat exchanger.

19: The thermal power plant of claim 17, wherein the heating system comprises at least one field of solar energy reflectors that, during diurnal periods, are arranged to reflect incident solar radiation to at least one receiver for heating the working fluid or, if present, the heat exchange fluid.

20: A thermal power plant comprising:
(a) means for generating a heated working fluid, comprising a solar energy collector system having solar energy reflectors;
(b) turbine means to which, in operation, the working fluid is directed;
(c) means for condensing working fluid vapour exhausted from the turbine means; and
(d) a cooling system associated with the condensing means and in fluid passage communication therewith, wherein the cooling system comprises a system of claim 4.

21: A carrier arrangement for use in a solar energy reflector system which comprises a carrier structure having:
a) a support structure for supporting a reflector element; and
d) one or more fluid channels attached to the support structure or the reflector element, wherein the fluid channels are at least partially shaded by the reflector element.

22: The carrier arrangement of claim 21, wherein the support structure is a platform.

23: The carrier arrangement of claim 22, wherein the platform comprises a panel-like platform which is formed with stiffening elements in the form of corrugations and wherein the reflector element is supported upon the crests of the corrugations.

24: The carrier arrangement of claim 22, comprising a frame portion that includes hoop-like end members between which the platform extends.

25: The carrier arrangement of claim 24, wherein the frame portion comprises a space frame.

26: The carrier arrangement of claim 24, wherein each of the hoop-like end members has a channel-section circumferential portion, and wherein the support members comprise spaced-apart supporting rollers which track within the circumferential portion of the associated end member.

27: The carrier arrangement of claim 24, comprising support members which support the frame portion by way of the end members and which accommodate turning of the carrier structure about an axis of rotation that is substantially coincident with a longitudinal axis of the reflector element when supported by the platform.

28: The carrier arrangement of claim 22, wherein the fluid channels are in heat conductive relationship with the platform.

29: The carrier arrangement of claim 22, wherein the fluid channels are attached to the platform by frictional engagement.

30: The carrier arrangement of claim 22, wherein the fluid channels are attached to the platform by glue.

31: The carrier arrangement of claim 21, wherein the fluid channels comprise conduits.
